(19) United States
(12) Patent Application Publication
(10) Pub. No.: US 2026/0184053 A1
(43) Pub. Date: Jul. 2, 2026

(54) MULTILAYER FILM AND METHOD OF PREPARATION THEREOF

(71) Applicant: COSMO FIRST LIMITED, New Delhi (IN)

(72) Inventors: Anil GAIKWAD, Aurangabad (IN); Nagesh KOLHE, Aurangabad (IN)

(21) Appl. No.: 19/122,788

(22) PCT Filed: Oct. 20, 2023
(86) PCT No.: PCT/IN2023/050966

§ 371 Date: Apr. 21, 2025

(30) Foreign Application Priority Data
Oct. 21, 2022 (IN) 202211060427

(51) Int. Cl. B32B 27/30; B32B 27/08; B32B 27/32; B32B 33/00; B32B 37/15; B32B 37/24; B32B 38/00; B32B 43/00

(52) U.S. Cl. CPC B32B 27/306; B32B 27/08; B32B 27/32; B32B 33/00; B32B 37/153; B32B 38/0008; B32B 43/00; B32B 2037/243; B32B 2250/02; B32B 2250/246; B32B 2255/10; B32B 2255/26; B32B 2270/00; B32B 2307/518; B32B 2307/7376; B32B 2307/75; B32B 2310/14; B32B 2323/043; B32B 2323/10; B32B 2331/04; B32B 2590/00

(57) ABSTRACT

The present invention disclosure provides a multiplayer film comprising a base layer, a print receptive and ink absorptive layer and its preparation method thereof. The present disclosure provides a top coating layer comprises of an acrylic-polyurethane dispersion/emulsion, resin intended to enhance the surface properties and ink drying. Furthermore, the present disclosure relates to use of multilayer film in the small and large format graphic films, advertising media, promotional media, vehicle and product wrap and other commercial applications. The present invention disclosure provides an efficient, cost-effective and eco-friendly process.

### TECHNICAL FIELD

The present disclosure relates to a multilayer film for advertising and printing media, such as outdoor/indoor graphic applications. The present disclosure relates to a multilayer film comprising a base layer, print receptive layer, and top coating layer which has solvent and eco-solvent ink receptor coating. The present disclosure also relates to a method for the preparation of multilayer film. The multilayer film may be clear, transparent, translucent, opaque white, or have other desirable optical properties. The multilayer film of the present disclosure to the use of small and large format graphic films, advertising media, promotional media, vehicle and product wrap, and other commercial applications.

### BACKGROUND

Polyvinyl chloride (PVC) films have been extensively used in advertising and print media, such as outdoor/indoor graphic applications. These applications include flex banner hoardings, graphics, signage, architectural and wall sticker, pressure-sensitive labels, wrap film, flooring film etc. However, the uses of PVC film have several drawbacks like it cannot be recycled, the PVC is typically heavily plasticized leading to concerns about the plasticizer composition and contamination of the plasticizer onto other substrates. Also, PVC processing, usage, and disposal pose potential biological hazards due to dioxin emission, presence of halogens, usage of carcinogenic vinyl chloride monomer, etc. All these drawbacks lead several countries to take initiatives to reduce or even eliminate PVC-based products from the consumer marketing, promotional and advertising product streams. Many region of world has already put stringent rule on single use of polymer and avoid to use PVC based films in the support of sustainability.

U.S. Pat. No. 6,589,636 B2 discloses co-extruded multilayer film having solvent inkjet ink receptive layer. It provides an image receptor medium comprising an extruded image receptive layer that is receptive to Solvent-based inkjet ink. The image receptive layer comprises a blend of a) a carrier resin comprising modified polyolefin or polyurethane resin, or combinations thereof and b) an ink absorptive resin compatible with said carrier resin and present in an effective amount and having a Hildebrand Solubility Parameter of said absorptive additive within about 3.1 (MPa)′ of the solvent of the ink, wherein the image receptive layer has an ink Solvent absorption of at least 50% greater than a film of carrier resin alone.

U.S. Pat. No. 9,315,064B2 discloses a co-extruded multilayer non-PVC film which is receptive to multiple varieties of ink like eco-solvent, mild-solvent, UV ink, and latex ink. Multilayer film having a thickness of at least about 0.6 mils is constructed using thermoplastic polyurethane or ethylene-methyl acrylate random copolymers.

WO 2011/109692 A1 describes non-PVC film that is suitable for use in connection marketing promotions, graphics, branding campaigns, and other printed or imaged communication-based initiatives. Non-PVC films include a top layer and a bottom layer. The top layer includes a polyurethane, polyurethane-acrylic copolymer, polyurethane-acrylic blend, or urethane-acrylic hybrid polymer. The bottom layer includes an emulsion-based, solvent-based, or extruded non-PVC-based polymer.

US 2005/271864 A1 disclose a multilayered thermoplastic film comprising a thermoplastic core layer having a first side and a second side. The thermoplastic film further comprises at least one abrasion resistant first thermoplastic skin layer overlying the first side of the core layer; wherein the first skin layer is comprised of an ionomer derived from sodium, lithium or zinc and an ethylene/unsaturated carboxylic acid copolymer; at least one second thermoplastic skin layer overlying the second side of the core layer; at least one layer of a pressure sensitive adhesive overlying the second thermoplastic skin layer.

US 2016/257153 A1 disclose a PVC free printable media and the laminate is “particularly adapted 20 for use with solvent inkjet ink, eco solvent inkjet ink etc”. The printable media containing a self adhering printable compositions for digital printing and prepared by coating of the self adhering printable composition on an untreated nonwoven substrate. The printable composition comprises an ethylene vinyl acetate carbon monoxide terpolymeric resin component, an ethylene copolymer resin component; and a filler. The ratio of the ethylene copolymer resin component, ethylene vinyl 25 acetate carbon monoxide terpolymer and the filler is 60:20:20 by weight. The printable composition further comprises zine ionomer as a gloss enhancer.

EP2740599 B1 describes the extrusion coating method as a key step in a series of multilayer construction processes to make a graphics film that can be used in a laminate for graphic application. The invention relates to a process for making a graphic film which includes, a) die coating and drying an ink-receptive layer onto a carrier web, b) extrusion coating a polyolefin material onto the ink-receptive layer of step (a), and c) removing the carrier web from the ink-receptive layer to expose a surface of the ink-receptive layer wherein the graphics film is halogen-free and the surface is glossy. Preferably, the carrier web is a polyester film, such as PET. The ink-receptive layer is a vinyl acetate homopolymer or copolymer or the mixture of, an acrylic copolymer or its mixture with a vinyl acetate/ethylene copolymer, a vinyl acetate/ethylene copolymer, and acrylic hybrid, or a polyurethane-containing polymer.

None of the above prior arts disclose a Non-PVC film that has the capability of printing with both solvent and eco-solvent ink simultaneously. Noticeably, now day's eco-solvent is getting more popular in inkjet due to its less harm to the environment and human health. Resins used in the above disclosures to make non-PVC films are much more expensive, therefore it is very hard to sustain in terms of price as compared to widely used PVC film. In order to promote the cost effective and environmentally friendly alternative of PVC film, the alternative must be less expensive and comparable price with PVC. Therefore, it would be desirable to produce a new non-PVC film with efficient printing with less-expensive price.

### Objectives

The objective of the present disclosure is to provide a cost-effective and environmental friendly non-PVC film which has a capability of printing with both solvent and eco-solvents based inkjet inks.

Another object of present disclosure is to provide a process for preparing the non-PVC print layer formulation for graphic application which can be used in small and large area indoor and signage application.

It is further object of the present disclosure is to provide non-PVC film which is technologically efficient.

### SUMMARY

An aspect of present disclosure provides a multilayer film comprising: a base layer (3) having a thickness in the range of 60-120 microns; and a print receptive layer (2) having GSM in the range of 15-20; and a top coating layer (1) having a GSM in the range of 5-10; wherein the print receptive layer (2) comprises of an ethylene-vinyl acetate (EVA) copolymer resin and an ink absorptive resin; wherein the top coating layer (1) comprises of an acrylic-polyurethane emulsion/dispersion.

Another aspect of present disclosure provides a method of preparation of a multilayer film comprising: i) treating a base layer (3) to obtain treated base layer; ii) extrusion coating a print receptive layer (2) on the treated base layer (3) to obtain an intermediate film, solution coating a top coating layer (1) on the intermediate layer to obtain the multilayer film. Wherein the print receptive layer (2) comprises of an ethylene-vinyl acetate (EVA) copolymer resin and an ink absorptive resin, and wherein the top coating layer (1) comprises of water-based acrylic-polyurethane emulsion/dispersion.

These and other features, aspects, and advantages of the present subject matter will become better to understood with reference to the following description. This summary is provided to introduce a selection of concepts in a simplified form. This summary is not intended to identify key features or essential features of the subject matter, nor is it intended to be used to limit the scope of the subject matter.

### DETAILED DESCRIPTION OF DRAWINGS

The below detailed description of the invention will be better understood when read in conjunction with the appended drawings. For the purpose of assisting in the explanation of the invention, there are shown in the drawings embodiments which are presently preferred and considered illustrative. It should be understood, however, that the invention is not limited to the precise arrangements and instrumentalities shown therein.

The invention will now be described, by way of example, with reference to the accompanying drawings, in which:

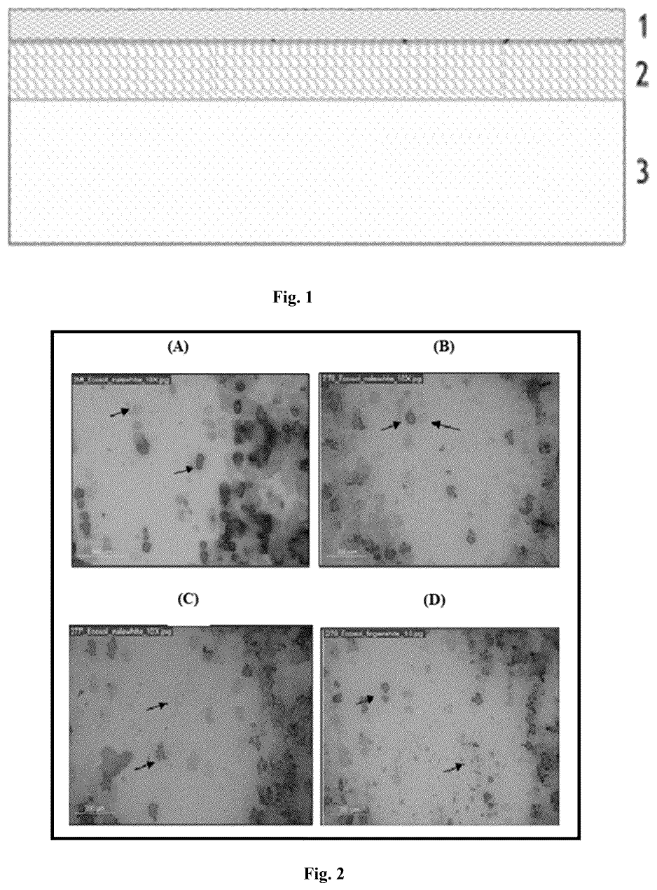

FIG. 1 shows the structure of multilayer film.
1. shows a top coating layer of multilayer film.
2. shows a print receptive layer of multilayer film.
3. shows a base layer of multilayer film.

FIG. 2 shows an optical microscope images of printed substrate (with eco-solvent) on A) PVC benchmark film B) EC1_1 C) EC1_2 D) EC1_3.

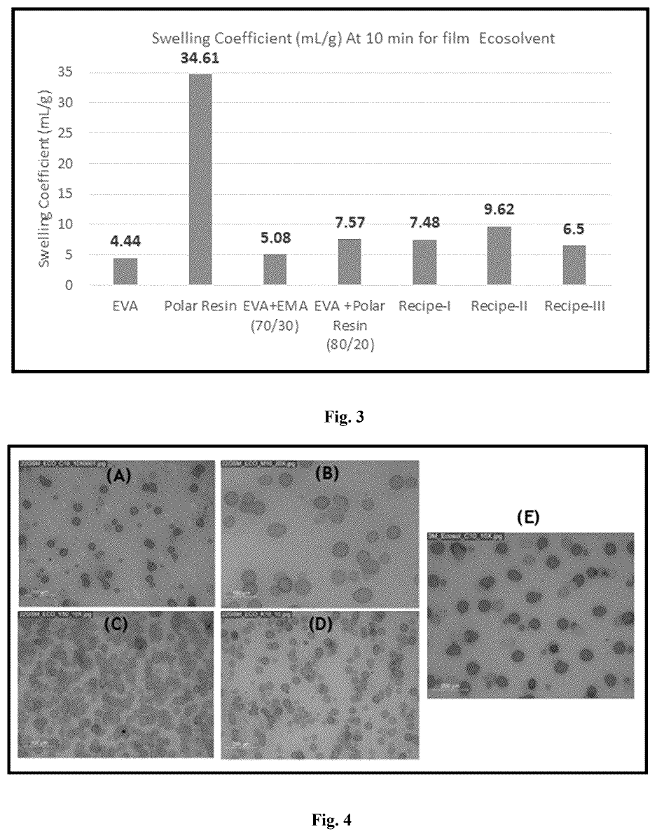

FIG. 3 shows a graphical representation of swelling coefficient (mL/g) studies for hot pressed film of resin and blends used for EC2 Trial in eco-solvent.

FIG. 4 shows an optical microscope images of printed substrate (with eco-solvent) on SC1 substrates.

### DETAILED DESCRIPTION

The present disclosure provides a multilayer film comprising: a base layer (3) having a thickness in the range of 60-120 microns; and a print receptive layer (2) having GSM in the range of 15-20; and a top coating layer (1) having a GSM in the range of 5-10; wherein the print receptive layer (2) comprises of an ethylene-vinyl acetate (EVA) copolymer resin and an ink absorptive resin; wherein the top coating layer (1) comprises of an acrylic-polyurethane emulsion/dispersion.

The base layer disclosed in the present disclosure is selected from the group consisting of biaxial oriented polypropylene (BOPP), blown polyethylene (PE), polyolefin, polyester (e.g. polyethylene terephthalate), and polycarbonate, polyamide, polystyrene, polyurethane and ethylene acrylate copolymer.

The print receptive layer disclosed in the present disclosure comprises 65 to 90 wt % of ethylene-vinyl acetate (EVA) copolymer resin and 10-35 wt % of ink absorptive resin.

In the present disclosure, the ink absorptive resin is an olefin-based copolymer, wherein the olefin-based copolymer is a reaction product of an olefin monomer and polar monomers, wherein the olefin monomer is selected from the group consisting of ethylene, propylene and alkyl substituted olefins, wherein the polar monomers are selected from the group consisting of vinyl acetate, carbon monoxide, n-butyl acrylate, acrylamide, vinyl alcohol, methyl acrylate, styrene, t-butyl acrylate, ethyl-hexyl acrylate, hydroxyethyl methacrylate (HEMA), allyl polyethylene glycol (APEG), Acrylonitrile and acrylic acid.

In some embodiment, the present disclosure provides an inkjet ink receptive medium comprising a single extrudable print receptive layer. The print receptive layer is a layer that is receptive to both solvent-based and eco-solvent based inkjet ink. Both inks are non-aqueous. The print receptive layer comprises an either single or blend of resin but most preferably efficient ink receptive layer is blend of 2 or 3 resins. Bilayer film in accordance with embodiments of present disclosure is shown in FIG. 1 in which layer “2” is print receptor layer, which is extrusion coated (15-20 micron) on the base film “3” (80-100 micron). The print layer “2” can be top coated with additional solution coating layer “1” (5-10 GSM) to enhance the surface topography of the print layer and achieve desired surface properties to the print layer.

Print layer “2” may be constructed from single thermoplastic resin such ethylene-vinyl-acetate (EVA). EVA resin that may be use for as print layer in present disclosure includes those sold under trade name of ATEVA2821A (VA content 28%) from Celanese Corporation, USA, Escorene FL01418 (VA content 18%) from Exxon Mobile, E220L/E221L (VA content 22%) from Hanwa Corporation, and APEEL1181 an acid/acrylate modified EVA (VA content 22%) from Dow. EA28025 from LG Chem Ltd.

In some embodiments, in order to enhance the ink solvent absorbency of EVA, the EVA resin may be blend with other polar resin in appropriate proportion, to form blend layer. Ink absorptive resin provides increased solvent absorbency to the print receptive layer such that ink bleeding and running is eliminated during printing. Useful ink absorptive resin is generally olefin-based copolymer. Generally, copolymers comprising the reaction product of olefin monomers and a sufficient amount of at least one polar monomer (modified olefin resins) provide the desired solvent absorptive resin. Specific examples of useful copolymers include copolymers of ethylene methyl acrylate ELVALOY1330 (MA content 20%) from Dow Chemical Corporation and terpolymers of ethylene and any two polar monomers, for example, Vinyl acetate, carbon monoxide (ELVALOY741) from Dow Chemical Corporation. Typically, the ink absorptive resin is present in the print receptive layer at a level of from about 15 to about 30 wt %. The main (bulk) EVA resin present in the print receptive layer at level of from about 85 to 70 wt. %. Typical thickness of print layer is ranging from 15 to 20 micron. In other embodiments, the blend of EVA with above mentioned polar resins offers an enhanced ink solvent absorbency than EVA alone. The ink solvent absorption capability for EVA resin alone is compared with various blends of EVA with polar resins by studying the swelling coefficient in solvent and eco-solvent. The experimental data for same is described in more detail in the examples section of this application and it is to be understood that the test described below is not limited to a particular solvent.

The use of additional solvent absorption additive resin may be useful to improve the ink drying ability of print layer and help to avoid ink bleeding and to improve the image quality. Specific examples of such useful resin include copolymers of methyl methacrylate with butyl methacrylate. Such copolymer may use in this disclosure is sold under name of “DINALB106” from Mitsubishi Chemical Corporation. The incorporation of butyl acrylate co-monomer into methyl methacrylate resins reduces the solubility parameter of the resulting (meth)acrylic resin such that the Solubility parameter of the resin more closely matches that of the solvent system in the inks, thereby providing faster Solvent absorption for the print receptive blend. The incorporation of this co-monomer into (meth)acrylic resin also typically reduces the glass transition temperature of the (meth) acrylic resin which may also facilitate Solvent uptake by the image receptive layer. Combinations of Such resins may also be used as the ink absorptive resin. Typically, the additive ink absorptive resin is present in the print receptive layer at a level of from about 10 to about 35 wt. %. The ink absorptive resin is present in the print receptive layer in an effective amount that improves the ink Solvent absorbency of bulk EVA resin alone.

The print receptive layer may include one or more filler materials. Inorganic fillers Such as titanium dioxide and calcium carbonate, and the like are a preferred additive in order to impart one or more of desirable properties such as improved Solvent absorption, improved dot gain and color density, and improved abrasion resistance. The concentration of such fillers in the image receptive layers of the disclosure typically range from about 0.1% to about 25% by weight. In another embodiment, the concentration of such fillers in the print receptive layers of the disclosure typically range from about 0.5% to about 15% by weight.

To enhance durability of the print receptive layer, especially in outdoor environments exposed to Sunlight, a commercially available UV light stabilizer, and free-radical scavengers may be used. Ultraviolet light stabilizers can be present in amounts ranging from about 0.1 to about 0.2 weight %. Benzotriazole type UV-absorbers are commercially available from Cytec Industries Inc. (Solvay) under the trade designation “CYASORB® UV-5411”. Free-radical Scavengers can be present in an amount from about 0.2 to about 0.3 weight %. Non limiting examples of free-radical Scavengers include hindered amine light stabilizer (HALS) compounds and commercially available from Cytec Industries under the trade designation “CyaSorb M528”.

In another embodiment of the disclosure, a base substrate film “3” (FIG. 1) is included in the print receptor medium, for example, to reduce the cost and/or enhance the physical properties of the medium. The base film is most commonly white and opaque for graphic display applications, but could also be transparent, translucent, or coloured opaque. Base film “3” can comprise any polymer having desirable physical properties for the intended application. Properties of flexibility or stiffness, durability, tear resistance, conformability to non-uniform Surfaces, die cuttability, weatherability, Solvent resistance (from Solvents in inks) heat resistance and elasticity are examples. For example, a graphic marking film used in Short term outdoor promotional displays typically can withstand outdoor conditions for a period in the range from about 3 months to about one year or more and exhibits tear resistance and durability for easy application and removal. The material for the base film is a resin capable of being extruded or coextruded into a substantially two-dimensional film and is preferably resistant to Solvents used in inks. “Resistant to Solvents in inks’. If used in combination with an adhesive on the opposite Side of the receptor layer, “significant’ means the film does not allow enough Solvent to pass through the film to negatively impact the adhesion performance of the underlying adhesive layer. For example, the barrier layer would prevent solvents from plasticizing the adhesive layer. Examples of suitable materials base film include biaxial oriented Polypropylene (BOPP) and PE (polyethylene). The base film may also contain other components such as pigments, fillers, ultraviolet Stabilizing agents, Slip agents, antiblock agents, antistatic agents, and processing aids familiar to those skilled in the art. The base film is commonly white opaque, but may also be transparent, colored opaque, or translucent. A typical thickness of the core layer “3” is in the range from 60 mic to 90 mic. However, a useful thickness is generally determined based on the requirements of the desired application.

In another embodiment, the print receptive layer “2” (FIG. 1) may also be obtained by solution coating of water based acrylic-polyurethane emulsion/dispersion on to the base film “3” to form print absorptive layer for solvent and eco-solvent based inks. In some other embodiment, the already extrusion coated print layer “2” (explained in above sections) may be top coated with solution coating “1” (FIG. 1) which leads to the improvement in the surface properties and enhanced solvent absorption and ink adhesion on the print layer. Such water based acrylic emulsion/dispersion used in this present disclosure is sold under name of PRINTRITE DP-265 by Lubrizole Corporation. This water based PVC-free solution is made up of acrylic-polyurethane hybrid dispersion. The dispersion can be coated with approximate of 20-22 GSM when used alone as print layer “2”, whereas the GSM can be reduced up to 5-10 GSM when top coated “1” (FIG. 1) on the already extrusion coated print layer “2”.

In another embodiment, acrylic-polyurethane hybrid emulsion/dispersion coating layer “1” used to top coat on the extrusion coated layer “2” (FIG. 1) is mixed/formulated with the other hard binders, clay fillers (Kaolin), and slip/antiblock additives which leads to the improvement in the surface properties (scratch resistance, ink absorbency & ink adhesion). The hard binders used in this disclosure is sold under the name of OKS-8118 by SOARUS (a group company of MITSUBISHI CHEMICAL) and Neorez R4000 by DSM. OKS-8118 is made up of a poly(vinyl alcohol) and R-4000 is made up of aliphatic urethane hybrid dispersion. The clay fillers (Kaolin) used in this disclosure is sold under name of ASP G90 by BASF Corporation & it is made up of aluminum silicate (pulverized powder). The slip/antiblock additives used in this disclosure is sold under name of Michem®Lube 160RPH by Michelman. The LUBE 160RPH is made up of a nanoscale wax emulsion, which are mostly carnauba and paraffin-based.

The image receptor media of the disclosure may also have a tie layer (not shown in FIG. 1) between print receptive layer “2” and the base film “3”. A tie layer is used to improve adherence between the print receptive layer and the base film layer. Useful tie layers for extrusion coating may use the polyethyleneimine which are commonly used to enhance the adhesion of extrusion coated layers. The ties layer used in this disclosure is available under name of “Mica X131A”. Tie layers can be applied to the core layer along with ozone by Solvent coating processes. The print receptor medium “2” of this disclosure can be made by an extrusion coated onto a Substrate or a base layer or other Support “3”. The finished print receptor medium may require Surface treatment methods Such as corona treatment to improve the image receptivity of the image receptor medium for certain applications.

In another embodiment of the present disclosure, a method of preparation of a multilayer film comprising: i) treating a base layer (3) to obtain treated base layer; ii) extrusion coating a print receptive layer (2) on the treated base layer (3) to obtain an intermediate film, solution coating a top coating layer (1) on the intermediate layer to obtain the multilayer film, wherein the print receptive layer (2) comprises of an ethylene-vinyl acetate (EVA) copolymer resin and an ink absorptive resin, and wherein the top coating layer (1) comprises of water based acrylic-polyurethane emulsion/dispersion.

In some embodiment of the present disclosure, the print receptive extrusion coated layer (2) is subjected to solution coating top layer (1) to obtain the multilayer film, wherein the solution coating comprises GSM in the range of 5-10, acrylic-polyurethane dispersions in the range of 74-78%, kaolin clay powder in the range of 6.5-8.0%, nano wax emulsions in the range of 7.0-9.5% and hybrid polyurethane dispersion in the range of 10.0-12.0%.

The print layer is formed by 15-20 GSM extrusion coating of ethylene-vinyl acetate (EVA) copolymer followed by 5-10 GSM ink absorptive coating of acrylic-polyurethane dispersion.

The base layer disclosed in the present disclosure is selected from the group consisting of biaxial oriented polypropylene (BOPP), blown polyethylene (PE), polyolefin, polyester (e.g. polyethylene terephthalate), and polycarbonate, polyamide, polystyrene, polyurethane and ethylene acrylate copolymer.

In one embodiment, the present disclosure provides, the base layer is subjected to corona treatment followed by coating with a primer layer of polyethyleneimine and ozone to obtain the treated base layer (3).

The imaged, non-PVC sheets may be a finished product or an intermediate and are useful for a variety of articles including Signage and commercial graphics films. Commercial graphic films include a variety of advertising, promotional, and corporate identity imaged films. The films typically comprise a pressure sensitive adhesive on the non-viewing Surface in order that the films can be adhered to a target Surface Such as an automobile, truck, airplane, billboard, building, awning, window, floor, etc.

The present disclosure also provides a non-PVC film discloses in this disclosure has capability of printing with both solvent and eco-solvent based printing inks with efficient, cost-effective and eco-friendly. Further, the present disclosure provides use of PVC free film in the small and large format graphic films, advertising media, promotional media, vehicle and product wrap and other commercial applications.

### EXAMPLES

The following examples are given by way of illustration of the present disclosure and should not be construed to limit the scope of present disclosure. It is to be understood that both the foregoing general description and the following detailed description are exemplary and explanatory only and are intended to provide further explanation of the subject matter.

### Materials and Methods

Eco solvent Printing was conducted on all the film Samples and benchmark PVC samples using an EPSION printer “SUPER color S40670, 10 pL. & Mimaki printer “JV150-160 BS”. The printer was operated in 4, 6 and 8 pass mode with a dryer temperature setting of 45° C. Solvent based printing is conducted on Gongzheng group GZT3202AU, 35 pL. The printer was operated in 4 and 8 pass mode with a dryer temperature setting of 35-38° C.

Overall, the image quality and dot size of an individual printed ink dot was measured on the image receptor film using an optical microscope. Adhesion of the ink to the substrate measured on the articles. The articles were conditioned at room temperature at least 24 hours prior to adhesion measurement, which was conducted by Tape Test. Qualitative evaluation of image quality for the various print receptive films was accomplished by observing running or bleeding of the ink during printing, if any; the resolution of the image, and the colour density relative to an PVC film. These qualitative evaluations are reported as “comments’ in the tables below.

### A) Extrusion Coating of PVC-Free Print Layer

### Example 1: (Comparative)

Approximately, 20 GSM thick layer of EVA (VA content 22-28%) resin or its blend with ethylene methacrylate (EMA, MA content 20%) copolymer resins is extrusion coated onto the blown HDPE base film. No prior pre-compounding of the resins was done. Extrusion temperature was kept in the range of 210° C. to 230° C. Base substrate was corona treated before extrusion coating. The corona discharge is secondary treatment used to improve the wettability of the polymer film surface in order to improve the adhesion of coating, ink, adhesives etc. After the corona discharge treatment, polar functional groups can be generated on the molecular chain of the polymer material to meet the pre-treatment requirements. The secondary CT was also applied to coated layer.

TABLE 1
Components of Print Layer Used in EC1 and
Its Process and Printing Observation

| Extrusion | Print layer | | |
|---|---|---|---|
| Coating | components | Process Observation | Printing Observation |
| EC1_1 | 100% EVA | Light Gel Observe | Ink runs a lot and |
| | | in Sample | bleed, poor |
| | | | absorption of solvent, |
| | | | good ink adhesion |
| EC1_2 | 85% EVA + | Gels observe | INK drying is |
| | 15% EMA | throughout width, | improved, INK |
| | | Coating layer | bleeding is observed, |
| | | adhesion is poor, | good ink adhesion |
| | | Coating layer is tacky | |
| EC1_3 | 70% EVA + | Gels observe | INK drying is |
| | 30% EMA | throughout width, | improved, slight INK |
| | | Coating layer | bleeding is observed, |
| | | adhesion is poor, | good ink adhesion |
| | | Coating layer is tacky | |

Note:
In all cases, the above print layer is extrusion coated (20GSM) on the HDPE base film (70 mic).

Example 1 is provided to illustrate the effectiveness of varying ratio of ethylene methacrylate copolymer with EVA in blend. This example also intended to check performance of print layer in 10 terms of inkjet image quality. The composition used to obtain the print receptor layer is summarized in Table1 with comments on the processes and printing observation also given in Table 1. The physical properties are summarizing in the Table 3.

According to the observation made in Table 1, the print receptive layer made solely from (EVA) resin did not have sufficient ink solvent absorbency to prevent the ink from running and bleeding. In contrast, a print receptive layer made from blend of EVA and EMA shows improved ink drying. When the incorporation of EMA is increased to 30% in the blend the ink drying is improved again along with less ink bleeding was observed.

The above fact was also being verified experimentally when the printed films are characterize using optical microscope. The optical microscope image shown in FIG. 2 for all the films. The inkjet dot is highlighted by arrow. The image A is for benchmark PVC film; the image shows well defined dot shape for image printed on the PVC film. The non-PVC film which are obtained with 100% EVA (EC1_1) shows blurry images with the dot in disperse shape, the dot gain is high and dot size is high. In film containing blend of EVA with EMA shows improved images and dot shape, the dot gain is less (image C and D). This means the incorporation of EMA resin helps for better solvent absorption and ink drying for solvent and eco-solvent in inkjet printing.

Further the solvent absorption capacity of resin used in example 1 is estimated by doing swelling studies in both solvent and eco-solvent and results are mentioned in Table 2. Table 2 clearly shows that the EMA has higher swelling coefficient than the EVA and Therefore blend of EVA/EMA has shown improved solvent absorbency and ink drying.

TABLE 2
Swelling coefficient studies of different resin in solvent and eco-solvent
Swelling Coefficient (mL/g) At 10 min

| Polymer | Ecosolvent | Solvent |
|---|---|---|
| EVA | 2.74 | 6.78 |
| EMA | 3.62 | 7.08 |

TABLE 3
Properties of Non-PVC film of EC1

| Properties | Unit | EC1_1 | EC1_2 | EC1_3 |
|---|---|---|---|---|
| Thickness | μm | 85-90 | 85-91.5 | 78.2-86.9 |
| GSM | g/m² | 78.66-88.79 | 78.83-91.75 | 78.0-90.86 |
| Gloss (45°) | Gdn | 10.4-11.0 | 10.0-11.0 | 10.3-10.8 |
| Opacity | % | 77.9-78.0 | 72.06-73.03 | 79.4-79.8 |
| WI | % | 86.79-87.08 | 87.90-88.51 | 86.66-87.06 |
| YI | % | 3.31-3.38 | 3.03-3.16 | 3.42-3.54 |
| COF (Static/ | — | 0.88/1.2 | 1.02/1.76 | 1.21/1.92 |
| Kinetic) | | | | |
| Tensile | kgf/cm² | MD = 163-167 | MD = 186-194 | MD = 184 |
| strength | | TD = 188-199 | TD = 152-164 | TD = 196 |
| (MD/TD) | | | | |
| Elongation | % | 579 | 579 | 579 |
| (MD/TD) | | | | |

### Example 2: (According to Invention)

Approximately, 20 GSM thick layer of EVA (VA content 22-28%) resin or its blend with ethylene-vinyl acetate-carbon monoxide terpolymer (polar resin) or acrylic copolymer (additive resin) resins is extrusion coated onto the HDPE base. The TiO2 and CaCO3 filler was added. The UV master batch is added in one of the trial (EC2_2). No prior pre-compounding of the resins was done. Extrusion temperature was kept in the range of 210° C. to 230° C. Base substrate was corona treating before extrusion coating. The secondary CT was also applied to coated layer. 28% VA content for EVA is used in these recipe (I, II, & III).

Example 2 is provided to illustrate the effectiveness of varying ratio of polar resin and additive resin with EVA in blend. This example also intended to check performance of print layer in terms of inkjet image quality. The example EC2_2 have been designed to a) lower the overall MFI of mixture due to presence of acid modified EVA in EC2_2 b) see the effect of acid modified EVA on the printing quality and coating surface properties. The EC2_1 Vs EC2_3 have been designed to see the difference between polar resin Vs additive resin on the image quality and absorption. The composition used to obtain the print receptor layer is summarized in Table 4 with comments on the processes and printing observation. The physical properties are summarizing in the Table 5.

According to observation made in Table 4, the uniform extrusion coating layer was obtained using the blend of EVA and polar resin and filler MB, except, few gels particles were observed. The extrusion process was very stable. When acid modified EVA was added as another component in the blend (EC2_2) the extrusion process was disturbed. There was heavy gels and holes was observed in extrusion flow, eventually the ununiformed coating was obtained on the base film. The coating is missed on the several places. In EC2_3 trial the blend of EVA and additive resin was used as extrusion coating layer. There were heavy gels and ununiform extrusion flow was observed which make difficulty for extrusion coating layer deposition on the base film, however, the extrusion layer deposition was improved when thickness is increased from 20 GSM to 30 GSM. The additional primer layer of Mica X131A was used in all cases (EC2) in order to improve the bond between base film “3” and print layer “2”.

TABLE 4
Components of Print Layer Used in EC2 and Its Process Observation

| Extrusion | | |
|---|---|---|
| Coating | Print layer components | Process Observation |
| EC2_1 | 65% EVA + 20% polar resin + | Randomly gel particle observed. |
| (Recipe -I) | 15% Pigment (TiO2 + CaCO3) | Overall extrusion process was good |
| | | and stable. |
| EC2_2 | 40% EVA + 25% polar resin + | Heavy gels and holes in extrusion |
| (Recipe -II) | 20% acid modified EVA + 15% | flow. Coating was not applied evenly |
| | Pigment (TiO2 + CaCO3) + | to the base substrate |
| | 0.4% UV stabilizers | |
| EC2_3 | 60% EVA + 25% additive resin + | Extrusion flow were disturbed due to |
| (Recipe-III) | 15% Pigment (TiO2 + CaCO3) | heavy gels and holes in flow. The |
| | | process was stabilized after increasing |
| | | the coating thickness from 20 mic to |
| | | 30 mic. Lines were observed on |
| | | coating layer |

Note:
The above print layer is extrusion coated (20GSM) on the HDPE base film (140 mic) in all cases. A base substrate is treated with primer layer of Mica X131A along with Ozone before extrusion coating.

In all Samples, ink picking was not detected after the Ink Adhesion Test, indicating reasonably good ink adhesion. Printing on all the films were obtained using solvent and eco-solvent. The printing results for both eco-solvent and solvent based inks of EC2 films were mentioned in Table 6. The best quality printing was observed on the EC2_2 film with rating of 4 out of 5 followed by the EC2_1 and EC2_3. However, in the view of process stability and print quality the EC2_1 film seems to be optimal. For solvent based printing however, the EC2_3 film found to be best for printing in which there was fastest ink drying is observed. The EC2_1 film also found to be optimum for solvent based printing.

Recipe I, II & III is obtained by mixing combinations of these commercial resins. The ELVALOY741 (polar resin) has highest swelling ability which is desired for ink solvent absorption, however, due to its undesired mechanical properties it cannot be used alone for extrusion coating. In other hand, EVA has lower swelling ability but it has optimal mechanical properties which is required for extrusion coating. Therefore, it is necessary to form blend of these which mixed with EVA to enhance the swelling of overall formulation (EVA+ELVALOY741). It is to be noted that the swelling ability of blend is expected to be lower than the ELVALOY741 and higher than the EVA.

TABLE 5
Properties of Non-PVC film of EC2

| Properties | Unit | EC2_1 | EC2_2 | EC2_3 |
|---|---|---|---|---|
| Thickness | μm | 151-162 | 158-164 | 162-180 |
| GSM | g/m² | 155.69-159.78 | 157.16-162.66 | 170.25-171.09 |
| Gloss (45°) | Gdn | 9.9-10.1 | 8.9-9.9 | 11.9-12.2 |
| Opacity | % | 86.9-87.3 | 86.1-88.0 | 90.1-90.8 |
| WI | % | 86.77-87.61 | 85.04-86.57 | 88.05-88.57 |
| YI | % | 3.67-3.89 | 3.96-4.35 | 3.34-3.40 |
| COF (Static/ | — | 1.91/1.76 | 1.71/1.64 | 1.17/1.16 |
| Kinetic) | | | | |
| Tensile | kgf/cm² | MD = 195-200 | MD = 230-241 | MD = 180-184 |
| strength | | TD = 175-180 | TD = 184-192 | TD = 173-180 |
| (MD/TD) | | | | |
| Elongation | % | 579 | 579 | 579 |
| (MD/TD) | | | | |

Further the solvent absorption capacity of resin used in example 2 is estimated by doing swelling studies in both solvent and eco-solvent. FIG. 3 shows the graphical view of swelling coefficient of resin. The swelling studies are done on the hot pressed film of resin and the blend (EC2_1=recipe I, EC2_2=recipe II, and EC2_3=recipe III). Data mentioned in the FIG. 3 clearly shows that the polar resin has higher swelling coefficient (7.8 time higher) than that of the EVA. For resin blend the all the recipe I, II and III film has higher swelling coefficient than the blend of (EVA+EMA) means it can give indication of higher solvent absorbency in the EC2 (example 2) trial than that of the previous EC1 trial (example 1). Within recipe I to III, the recipe II has highest swelling capacity which also reflect in their good printing behaviour with Eco solvent.

TABLE 6
Eco solvent and Solvent Printing Observation
on Non-PVC film of EC2

| | | | | |
|---|---|---|---|---|
| | Number | Heater | | Rating for |
| Extrusion | of | Temp | | printing |
| Coating | Passes | (° C.) | Remark | (out of 5) |

Trial -2 Eco solvent Based Printing

| | | | | |
|---|---|---|---|---|
| EC2-1 | 4 | 35-35-50 | Slight bleeding of INK | 3.5 |
| | | | is observed | |
| | 4 | 45-45-50 | Printing is improved | 3.5 |
| | | | with less ink bleeding | |
| EC2-2 | 4 | 35-35-50 | Good quality print was | 4 |
| | | | observed (less ink | |
| | | | bleeding, high color | |
| | | | density) | |
| EC2-3 | 4 | 35-35-50 | Printing was average | 3 |
| | | | with slight ink | |
| | | | bleeding was observed. | |

Trial -2 Solvent Based Printing

| | | | | |
|---|---|---|---|---|
| EC2-1 | 4 and 8 | 39 | Good drying of ink | 3 |
| EC2-2 | 4 and 8 | 39 | Slower drying than | 2.5 |
| | | | Trial2_1 | |
| EC2-3 | 4 and 8 | 39 | Fastest drying among | 4 |
| | | | all 3 trials | |

As shown in Table4 A higher opacity is observed in the EC2 trial (Opacity=86-90%) as compared to the EC1 Trial film (Opacity 74-78%) which is due to the use of a white TiO2 master batch. Good reproducibility of the extrusion coating process was observed by using EVA (with 28% VA) except there were few gel particles in extrusion coating. The use of primer (Mica X131A) along with Ozone gives relatively improved adhesion of PVC free extrusion layer (majorly EVA) on PE base film). The tackiness was slightly reduced by using acid-modified EVA and additive resin in recipes II and III respectively which can be seen from slightly reduced COF values in these films as compare to recipe I.

### Example 3: (Comparative)

Approximately, 20 GSM thick layer of EVA (VA content 22-28%) resin blended with ethylene-vinyl acetate-carbon monoxide terpolymer (polar resin) copolymer resins is extrusion coated onto the biaxial oriented polypropylene (BOPP) base film. No prior pre-compounding of the resins was done. EVA based UV master batch and antioxidant is added in some of the trial. Extrusion temperature was kept in the range of 180° C. to 200° C. Base substrate was corona treated before extrusion coating. The secondary CT was also applied to coated layer. The composition used to obtain the print receptor layer is summarized in Table 7.

TABLE 7
Components of Print Layer Used in EC3 and Its Process Observation

| Extrusion | | |
|---|---|---|
| Coating | Print layer components | Process Observation |
| EC3_1 | 80% EVA + 20% polar resin | Thickness & GSM variation observed. |
| EC2_2 | 79.35% EVA + 20% polar resin + | Large Thickness & GSM variation |
| | 0.25% AO + 0.4% UV stabilizers | observed. Curtain flow was unstable |

Note:
The above print layer is extrusion coated (20GSM) on the BOPP base film (80-100 mic) in all cases. A base substrate is treated with primer layer of Mica X131A along with Ozone before extrusion coating.

### B) Solution Coating of PVC-Free Print Layer

Solution coatings is applied on as such base film “3” (FIG. 1) or extrusion coated layer “2” (FIG. 1) films to enhance the inkjet printing ink absorbency and enhance the surface properties. These solution coatings are formulated with various ingredients and every ingredient have the specific role. In Table 8, listed the basic chemistry, appearance and active content of the solution coating ingredients.

TABLE 8
Coating Solution Raw Material Details

| | | | | Michem ® | |
|---|---|---|---|---|---|
| Coating | Print Rite ™ | | | Lube 160 | |
| ingredient | DP 265 | ASP G90 | PVA | PFP | Neorez R4000 |
| Chemical | Acrylic- | Kaolin clay | Polyvinyl | Nano wax | Hybrid |
| Nature | polyurethane | Powder | alcohol | emulsions | polyurethane |
| | dispersions | | | | dispersion |
| Appearance | White | White | White | Off-white | Semitransparent |
| | dispersion | powder | granular | liquid | liquid |
| | | | powder | | |
| % Solid | 41.0 to 44.0 | 100 | 100 | 24.5-25.5 | 34.0-36.0 |
| content | | | | | |
| pH | 8.0 to 9.0 | 7 | — | 4.0-7.5 | 8.0-9.5 |

### Example 4: (According to Invention)

SC1-Approximately 20-22 GSM thick layer of PVC-free acrylic-polyurethane emulsion/dispersion was coated onto the BOPP base film. Using 100 LPI gravure cylinder on pilot coating line. The coated solution is subsequently heat dried at 70-80° C.

Example 4 (SC1) is provided to see the performance of PVC-free solution coating in terms of print quality as compared to the extrusion coating. The composition used to obtain the print receptor layer is summarized in Table 9 and comments on the printing observation summarizing in the Table 10. The physical properties of print receptive coated surface are summarizing in the Table 11.

According to observation made in Table 10, the print receptive layer obtained by acrylic polyurethane emulsion/dispersion coating have sufficient ink solvent absorbency to prevent the ink from running and bleeding. The solvent absorbency of the solution-coated substrate is found similar to the benchmark PVC film. This fact also being verified experimentally when the printed films are characterized using an optical microscope. The optical microscope images were shown in FIG. 4 for SC1 films (A, B, C, and D, for C, M, Y, and K colour respectively) and benchmark PVC film (E). SC1 non-PVC film shows excellent ink drying, well-defined dots, and optimal dot gain which is found to be exactly similar to benchmark PVC film. This result shows that the solution coating route is also viable, however, the cost of the solution is found to be much higher than the extrusion coating route.

The surface properties of solution-coated film is very different from the extrusion coated surface. For example, the drastically high gloss value (54-56) is found to be in SC1 substrate, whereas the gloss value for extrusion coated substrate was in the range of only 10-11. Similarly, the low COF value was obtained in SC1 (0.266/0.175, Static/kinetic) as compare to the extrusion coated film (1.91/1.76). The controlled surface properties achievement is quite difficult in extrusion coating as compare to the solution coating

TABLE 9
Component of PVC free Solution Coating

| Solution | Coating | PrintRite ™ | ASP | PVA/PVB | Neorez | Michem ® |
|---|---|---|---|---|---|---|
| coatings | GSM | DP 265 | G90 | solution | R400 | Lube 160 PFP |
| SC1 | 20-22 | 100% | — | — | — | — |
| SC2 | 5-10 | 100% | — | — | — | — |
| SC3 | 5-10 | 94-96% | 4-6% | — | — | — |
| SC4 | 5-10 | 66-70% | 4-6% | 25-28% | — | — |
| SC5 | 5-10 | 74-78% | 6.5-8.0% | — | 10.0-12.0% | 7.0-9.5% |

TABLE 10
Details of Properties of Solution Coated product and Printing Observation

| | Base | | | Drying | Printing | |
|---|---|---|---|---|---|---|
| Coatings | substrate | SR^{a} | SR^{b} | time^{c} | Quality | Observation |
| SC1 | BOPP | 4 | 3 | 90 sec | 4 | Good ink drying & moderate |
| | | | | | | scratch resistance |
| SC2 | EC3_1 | 0 | 0 | 160 sec | 4 | Slightly slow ink drying. Poor |
| | | | | | | scratch resistance |
| SC3 | EC3_1 | 1 | 1 | 120 sec | 4 | Slight slow ink drying. Poor |
| | | | | | | scratch resistance |
| SC4 | EC3_1 | 4 | 3 | 180 sec | 1.5 | Slow ink drying & ink bleeding |
| | | | | | | observed. Improved scratch |
| | | | | | | resistance |
| SC5 | EC3_1 | 4.5 | 4.5 | 90 sec | 4.5 | Good ink drying with print quality. |
| | | | | | | Improved scratch resistance. |

SR^{a}—Scratch resistance on coated surface,
SR^{b}—Scratch resistance on printed surface,
Drying time^{c}—It is time taken to dry the ink, drying checked by touch dry method.

TABLE 11
Properties of solution coated multilayer film.

| | | Coatings | | | | |
|---|---|---|---|---|---|---|
| Properties | Unit | SC1 | SC2 | SC3 | SC4 | SC5 |
| Coating GSM | g/m2 | 20-22 | 5.5-6.5 | 6.5-8.0 | 6.5-8.0 | 6.5-8.0 |
| Gloss @ 45 | Gdn | 52-57 | 52-54 | 30-32 | 12.2-14.0 | 50.5-54.3 |
| COF (static/Dynamic) | — | 0.26/0.17 | 0.93/0.76 | 0.92/0.79 | 0.45/0.34 | 0.73/0.53 |
| Whiteness Index | L | 98.44 | 98.21 | 98.32 | 98.2 | 98.27 |
| | a | −0.78 | −0.76 | −0.79 | −0.66 | −1.06 |
| | b | 2.23 | 2.27 | 2.43 | 2.53 | 3.18 |
| | Wi | 86.94 | 85.69 | 85.56 | 85.07 | 82.24 |
| | Yi | 3.61 | 4.15 | 3.98 | 4.29 | 5.22 |
| | Opacity | 88.5 | 88.85 | 88.5 | 87.3 | 88 |

### Example 5: (According to the Invention)

SC2-Top coating of PVC-free acrylic-polyurethane coating has been done onto the previously extrusion coated print layer EC3_1 film, to further enhance the surface properties (COF and gloss) and to improve the surface smoothness. It was observed through the example 4 that the solution coating can improve the gloss drastically and reduce the COF. However, to reduce the cost, the solution coating GSM may be lower up to 5-10 GSM. It was thought that the extrusion coating (20 GSM) is already present there for ink solvent absorbency, the additional 5-10 GSM acrylic-polyurethane coating will help to further improve the surface properties (COF and gloss) and additionally can help to dry the ink faster.

The Examples 5 in this disclosure is to demonstrate the benefit of the top solution coating to improve the overall surface properties of the extrusion coated print layer. Also, the sequential deposition of the print layer by extrusion followed by solution coating is a new way to achieve the desired properties in this class of graphic film.

According to the observation made in Table 10, the print receptive layer obtained by acrylic-polyurethane based solution coating on to previously extrusion coated film (EC3_1) have sufficient ink solvent absorbency to prevent the ink from running and bleeding. As desired the surface properties of EC3-1 film is improved for example, the gloss value is enhanced from 10 to 40 and COF value reduce from 1.91/1.76 to 0.92/0.76. While other properties like opacity, whiteness and yellowness index are also within the limit. However, poor scratch resistance, slower ink drying, and relatively high coefficient of friction (0.92/0.76), was observed on the SC2 coated film surface. Therefore, the attempt was made to revise the coating recipe by adding clay filler particle in acrylic-polyurethane binder to modify the surface properties of coated surface. Clay filler disperse in the acrylic PU binder and this solution was coated on extrusion film. This clay particle forms the porous structure in to the polymer matrix and this micro porous nature of coated surface help to penetrate the solvent of the printing ink. The fa penetration of solvent results the improved drying rate of inkjet printing ink.

According to observation made in Table 10, SC3 coated film shows the fast ink absorbency and good quality of printing. But still printed surface has poor scratch resistance which leads to the scratch mark on printing surface. SC3 coated surface COF value was reduced only slightly up to 0.91/0.79. However, the gloss value is dropped from 52-54 to 30-32.

### Example 6: (According to the Invention)

The example 6 (SC4), in this disclosure is to demonstrate the benefit of the addition of hard polymer binder (high glass transition temp “Tg”) in the coating recipe in order to improve the scratch resistance of coated surface. PVA (polyvinyl alcohol) is widely used as binder for inkjet ink receptive coating in the aqueous-based inks due to its good film-forming characteristics, good binding strength, and a proven high impact on the colour gamut. However, pure PVA coatings gave a surface with high gloss variations, prolonged ink drying time, and cracked prints when using pigmented inks. It is also known that ink absorption is enhanced when PVA is used along with pigment with broad pores. PVA has higher glass transition temperature and therefore can form coating with hard surface & improved scratch resistance. PVA used in this example has crystalline particle form with lower solubility in the water at room temperature. Therefore, PVA was initially solubilize in hot water at 70-80° C. for 2-3 hours under mechanical stirring. Once it is dissolve in the water, the known weight of solution added in the coating recipe at varying weight proportions. Finally, SC4 coating solution has been applied on the previously extrusion coated print layer EC3-1 film and heat dried at 60-70° C.

According to observation made in Table 10, as desired the SC4 solution coating improved surface hardness property. But, the improved hard surface of coated product causes the slow penetration of the printing ink. The insufficient ink absorbency of SC4 solution coating surface layer causes the ink run ability and bleeding issue. Other surface properties like the COF value was reduced from 0.92/0.76 to 0.450/0.345; but the gloss value drastically decreased from 30-32 to 12.2-14.0. According to the observations of SC4 top coating, it's confirm the water soluble synthetic polymer benefit the surface hardness properties of coated product but negatively affects the print quality. Therefore, in next attempt modified the coating recipe with optimum balance of the porosity, surface hardness and solvent ink absorbency.

### Example 7: (Comparative)

The example 7 (SC5), in this disclosure is to demonstrate the benefit of the addition of hard polymer binder (polyurethane) and slip/anti-block additive (Michem® Lube 160 PFP) in the coating recipe in order to improve the scratch resistance. The polar urethane linkage in polyurethane (PU) resin will help in solvent absorbency & ink adhesion, whereas its high “Tg” will provide the hard surface film. Michem® Lube 160 PFP is a versatile family of nanoscale wax emulsions, which are mostly carnauba and paraffin-based. This additive provides the slip and anti-block properties. This paraffin wax has melting point between approximately 46 and 68° C. During inkjet printing process, print coated surface is exposed to the heat (40-50° C.) at this time the paraffin waxes present on the surface of film become soft and help to adsorb the printing ink. After the printing the film comes to the normal temperature and form the smooth surface. This smooth surface improves the scratch resistance on the printing surface. The weight proportions of ingredients is also important while developing the solution coating with optimum inkjet ink drying, good print quality and surface scratch resistance. For example, excess weight proportions of hard waterborne PU dispersion in coating recipe positively improve the surface scratch resistance property. But, simultaneously it negatively affects the ink absorbency as well as inkjet printing quality. This may happen due to excess weight proportion of hard ingredient form the hard surface film and slow down the solvent ink penetration rate which causes the slow drying and ink bleeding issue.

According to observation made in Table 10, SC5 solution coating applied on to extrusion coated film (EC3_1) showed the excellent ink solvent absorbency with good print quality. In fact, the solvent absorbency of SC5 solution coated substrate is found similar to the bench mark PVC film. This is also being verified experimentally when the printed films are characterizing using optical microscope. SC5 coated non-PVC films shows excellent ink drying, well defied dots, and optimal dot gain which is found to be exactly similar with bench mark PVC film. This SC5 solution coating coated surface before and after printing shows the excellent scratch mark resistance properties. The surface properties of SC5 coated films improved sharply like gloss value increased from 10 to 50.5-54.3 unit. The COF was reduced to the 0.730/0.530 from 1.91/1.76. The observation made in Table 10 confirm that combination of extrusion and solution coating route is also viable. This route is cost-effective, eco-friendly than standard PVC base film and high GSM acrylic solution coating route on PP film surface.

### Advantages of the Multilayer Film of the Present Disclosure:

1. The PVC free film can be simultaneously printed with both solvent and Eco solvents based inks, therefore single film can be used for wide applications.
2. Cost-effective
3. Eco-friendly
4. Sustainable
5. Efficient

Non-PVC film presented in this disclosure can find a good alternative application to the currently used PVC film. The PVC film has many drawbacks use a) it cannot be recycled 2) The plasticizer used in PVC film are harmful (potential carcinogen) to the human health 3) PVC is responsible for the production of cancerous chemical “dioxin”. Due to all the above-mentioned issues, the stringent rule is imposed by many governments in India as well as abroad on the use of PVC film. It is for sure that PVC film use will be banned in the future, in this regards the non-PVC film reported in this disclosure will have high market potential and a sustainable future for the advertising industry.

Adverting media is strongest way to communicate about a brand and any other required social publicity in various fields. In this regard, Non-PVC film disclose in this disclosure can find potential use in the graphic and advertising field for applications such as banners, signage, indoor/outdoor promotional graphics, in-shop branding, window graphic film, wallpaper, billboard, hoardings, graphic film for a vehicle like a bus and truck, etc.

1. A multilayer film comprising:
a treated base layer having a thickness in the range of 60-120 microns; and
a print receptive layer having GSM in the range of 15-20; and
a top coating layer having a GSM in the range of 5-10;
wherein the print receptive layer comprises 65 to 90 wt % of an ethylene-vinyl acetate copolymer resin and 10-35 wt % of an ink absorptive resin;
wherein the ink absorptive resin is an olefin-based copolymer; and
wherein the top coating layer comprises a water-based acrylic-polyurethane emulsion/dispersion.

2. (canceled)

3. (canceled)

4. (canceled)

5. The multilayer film as claimed in claim 1, wherein the olefin-based copolymer is a reaction product of an olefin monomer and polar monomers.

6. The multilayer film as claimed in claim 3, wherein the olefin monomer is selected from the group consisting of ethylene, propylene, and alkyl-substituted olefins.

7. The multilayer film as claimed in claim 3, wherein the polar monomers are selected from the group consisting of vinyl acetate, carbon monoxide, n-butyl acrylate, acrylamide, vinyl alcohol, methyl acrylate, styrene, t-butyl acrylate, ethyl-hexyl acrylate, hydroxyethyl methacrylate (HEMA), allyl polyethylene glycol (APEG), Acrylonitrile and acrylic acid.

8. A method of preparation of a multilayer film comprising the steps of:
treating a base layer to obtain a treated base layer having a thickness in the range of 60-120 microns;
extrusion coating a print receptive layer having GSM in the range of 15-20 on the treated base layer to obtain an intermediate film;
solution coating a top coating layer having a GSM in the range of 5-10 on the intermediate layer to obtain the multilayer film;
wherein the print receptive layer comprises 65-90 wt % of an ethylene-vinyl acetate copolymer resin and 10-35 wt % of an ink absorptive resin;
wherein the ink absorptive resin is an olefin-based copolymer; and
wherein the top coating layer comprises of water-based acrylic-polyurethane emulsion/dispersion.

9. The method as claimed in claim 8, wherein the print receptive extrusion coated layer is subjected to solution coating top layer to obtain the multilayer film.

10. The method as claimed in claim 8, wherein the solution coating comprises acrylic-polyurethane dispersions in the range of 74-78%, kaolin clay powder in the range of 6.5-8.0%, nano wax emulsions in the range of 7.0-9.5% and hybrid polyurethane dispersion in the range 10.0-12.0%.

11. The method as claimed in claim 8, wherein the print layer is formed by 15-20 GSM extrusion coating of ethylene-vinyl acetate (EVA) copolymer followed by 5-10 GSM ink absorptive resin of acrylic-polyurethane coating.

12. The method as claimed in claim 8, wherein the base layer is selected from the group consisting of biaxial oriented polypropylene (BOPP), blown polyethylene (PE), polyolefin, polyester, polycarbonate, polyamide, polystyrene, polyurethane and ethylene acrylate copolymer.

13. The method as claimed in claim 8, wherein the treatment of base layer comprises to corona treatment followed by coating with a primer layer of polyethyleneimine and ozone to obtain the treated base layer.

14. The multilayer film as claimed in claim 1, wherein the treated base layer is corona treated layer.

15. The multilayer film as claimed in claim 6, wherein the corona treated layer is treated coated with a primer layer of polyethyleneimine and ozone to obtain the treated base layer.
